(19) United States
(12) Patent Application Publication
(10) Pub. No.: US 2017/0291856 A1
(43) Pub. Date: Oct. 12, 2017

(54) SOLUTION PRECURSOR PLASMA SPRAY OF CERAMIC COATING FOR SEMICONDUCTOR CHAMBER APPLICATIONS

(71) Applicant: Applied Materials, Inc., Santa Clara, CA (US)

(72) Inventors: Jennifer Y. Sun, Mountain View, CA (US); Yikai Chen, Santa Clara, CA (US); Chengtsin Lee, Union City, CA (US)

(21) Appl. No.: 15/479,209

(22) Filed: Apr. 4, 2017

Related U.S. Application Data
(60) Provisional application No. 62/319,002, filed on Apr. 6, 2016.

(51) Int. Cl. C04B 35/505; C23C 4/134; C04B 22/14; C04B 41/00; C04B 35/626; C23C 4/16; C04B 41/45

(52) U.S. Cl. CPC C04B 35/505; C23C 4/16; C23C 4/134; C04B 41/4527; C04B 41/0054; C04B 35/62665; C04B 41/4533; C04B 22/147; C04B 2235/32

(57) ABSTRACT

Disclosed herein are methods for producing an ultra-dense and ultra-smooth ceramic coating. A method includes feeding a solution comprising a metal precursor into a plasma sprayer. The plasma sprayer generates a stream toward an article, forming a ceramic coating on the article upon contact.

### CROSS-REFERENCE TO RELATED APPLICATION

This application claims the benefit of priority of U.S. Provisional Patent Application Ser. No. 62/319,002, filed on Apr. 6, 2016, the disclosure of which is hereby incorporated by reference herein in its entirety.

### TECHNICAL FIELD

Embodiments of the present disclosure relate, in general, to coatings.

### BACKGROUND

In the semiconductor industry, devices are fabricated by a number of manufacturing processes producing structures of ever-decreasing size. Some manufacturing processes such as plasma etch and plasma clean processes expose a substrate support (e.g., an edge of the substrate support during wafer processing and the full substrate support during chamber cleaning) to a high-speed stream of plasma to etch or clean the substrate. The plasma may be highly corrosive, and may corrode processing chambers and other surfaces that are exposed to the plasma.

Plasma spray coatings are utilized to protect chamber components from processing conditions, in order to enhance on-wafer defect performance as well as the lifetime of the component. Typical chamber component coatings, however, can have inherent porosity, cracks, and rough surface finishes, which detract from their performance.

### SUMMARY

The following is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

Certain embodiments of the present disclosure relate to the production of ultra-dense and ultra-smooth coatings with enhanced defect performance for semiconductor processing chambers. In one aspect, a method includes providing an article, feeding a metal precursor solution into a plasma plume to generate a stream directed toward the article. The stream forms a ceramic coating on the article upon contact.

In another aspect, a method includes providing an article having a first ceramic coating, feeding a metal precursor solution into a plasma plume to generate a stream directed toward the article. The stream forms a second ceramic coating on the first ceramic coating upon contact.

### BRIEF DESCRIPTION OF THE DRAWINGS

The embodiments disclosed herein are illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 depicts a sectional view of a processing chamber according to an embodiment;

FIG. 2 depicts a sectional view of a plasma spray device according to an embodiment;

FIGS. 3A and 3B depict a sectional view of an exemplary chamber component with one and two coatings, respectively, according to an embodiment;

FIG. 4 is a flow diagram illustrating a process for producing a coating in accordance with an embodiment;

FIG. 5 is a flow diagram illustrating a process for producing a multilayered coating in accordance with an embodiment;

FIG. 6A is an x-ray diffraction spectrum for a first coating sample produced in accordance with an embodiment;

FIG. 6B is an x-ray diffraction spectrum for a second coating sample produced in accordance with an embodiment;

FIG. 6C is a graph of elemental analysis data for the first and second coating samples;

FIG. 7A is an electron micrograph top-down view of the first coating sample;

FIG. 7A is an electron micrograph cross-sectional view of the first coating sample;

FIG. 7A is an electron micrograph top-down view of the second coating sample; and

FIG. 7A is an electron micrograph cross-sectional view of the second coating sample.

### DETAILED DESCRIPTION OF EMBODIMENTS

Embodiments of the present disclosure provide an article, such as a chamber component for a semiconductor processing chamber. The ceramic coating may be formed on the substrate using solution-precursor plasma spray (SPPS) deposition. The ceramic coating may serve as a protective coating. In some embodiments, a coating stack may be deposited on the substrate, where the coating stack is composed of two or more SPPS-formed coatings. In such embodiments, each ceramic coating may be between about 10 micrometers to about 500 micrometers in thickness. Each ceramic coating may have a composition of one or more of Y₃Al₅O₁₂ (YAG), Y₄Al₂O₉ (YAM), Er₂O₃, Gd₂O₃, Gd₃Al₅O₁₂ (GAG), YF₃, Y₂O₃, YOF, Nd₂O₃, Er₄Al₂O₉, Er₃Al₅O₁₂ (EAG), ErAlO₃, Gd₄Al₂O₉, GdAlO₃, Nd₃Al₅O₁₂, Nd₄Al₂O₉, NdAlO₃, or a ceramic compound composed of Y₄Al₂O₉ and a solid-solution of Y₂O₃—ZrO₂. The ceramic coatings may alternatively have other compositions as described further below. The improved erosion resistance to multiple different plasma environments provided by one or more of the disclosed ceramic coatings may improve the service life of the chamber component, while reducing maintenance and manufacturing cost.

As used herein, the term “plasma resistant coating material” refers to a material that is resistant to erosion and corrosion due to exposure to plasma processing conditions. The plasma processing conditions include a plasma generated from halogen-containing gases, such as C₂F₆, SF₆, SiCl₄, HBR, NF₃, CF₄, CHF₃, CH₂F₃, F, NF₃, Cl₂, CCl₄, BCl₃ and SiF₄, among others, and other gases such as O₂, or N₂O. The resistance of the coating material to plasma (referred to herein as “erosion resistance” or “plasma resistance”) is measured through “etch rate” (ER), which may have units of Angstrom/min (A/min), throughout the duration of the coated components' operation and exposure to plasma. Plasma resistance may also be measured through an erosion rate having the units of nanometer/radio frequency hour (nm/RFHr), where one RFHr represents one hour of processing in plasma processing conditions. Measurements may be taken after different processing times. For example, measurements may be taken before processing, after 50 processing hours, after 150 processing hours, after 200 processing hours, and so on. A single plasma resistant material may have multiple different plasma resistance or erosion rate values. For example, a plasma resistant material may have a first plasma resistance or erosion rate associated with a first type of plasma and a second plasma resistance or erosion rate associated with a second type of plasma.

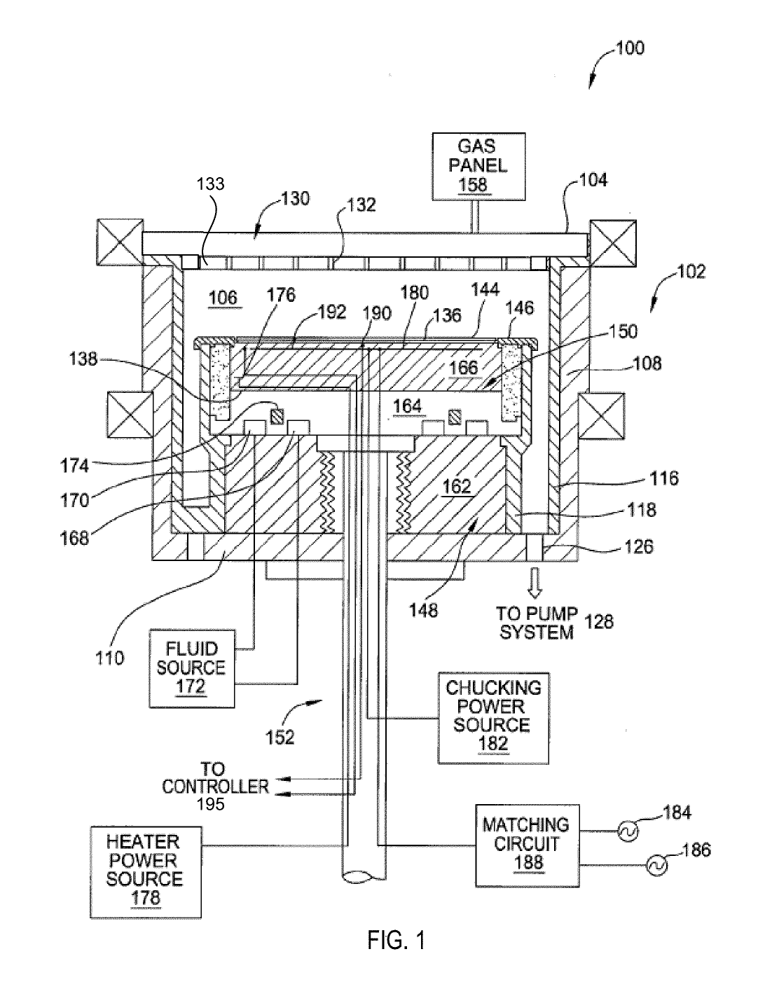

FIG. 1 is a sectional view of a semiconductor processing chamber 100 having one or more chamber components that are coated with a coating layer in accordance with embodiments of the present disclosure. The processing chamber 100 may be used for processes in which a corrosive plasma environment is provided. For example, the processing chamber 100 may be a chamber for a plasma etcher or plasma etch reactor, a plasma cleaner, and so forth. Examples of chamber components that may include a coating layer include a substrate support assembly 148, an electrostatic chuck (ESC) 150, a ring (e.g., a process kit ring or single ring), a chamber wall, a base, a gas distribution plate, a showerhead, a liner, a liner kit, a shield, a plasma screen, a flow equalizer, a cooling base, a chamber viewport, a chamber lid, and so on. The coating layer, which is described in greater detail below, may include, for example, one or more Y₃Al₅O₁₂, Y₄Al₂O₉, Er₂O₃, Gd₂O₃, Gd₃Al₅O₁₂, La₂O₃, YAG, YF₃, Y₂O₃, YOF, Nd₂O₃, Er₄Al₂O₉, Er₃Al₅O₁₂, ErAlO₃, Gd₄Al₂O₉, GdAlO₃, Nd₃Al₅O₁₂, Nd₄Al₂O₉, NdAlO₃, a ceramic compound composed of Y₄Al₂O₉ and a solid-solution of Y₂O₃—ZrO₂, or any other coating composition described herein.

As illustrated, the substrate support assembly 148 has a ceramic coating layer 136, in accordance with one embodiment. However, it should be understood that any of the other chamber components, such as those listed above, may also include a coating layer.

In one embodiment, the processing chamber 100 includes a chamber body 102 and a showerhead 130 that enclose an interior volume 106. Alternatively, the showerhead 130 may be replaced by a lid and a nozzle in some embodiments. The chamber body 102 may be fabricated from aluminum, stainless steel or other suitable material. The chamber body 102 generally includes sidewalls 108 and a bottom 110. One or more of the showerhead 130 (or lid and/or nozzle), sidewalls 108 and/or bottom 110 may include a coating layer.

An outer liner 116 may be disposed adjacent the sidewalls 108 to protect the chamber body 102. The outer liner 116 may be fabricated and/or coated with a coating layer. In one embodiment, the outer liner 116 is fabricated from aluminum oxide.

An exhaust port 126 may be defined in the chamber body 102, and may couple the interior volume 106 to a pump system 128. The pump system 128 may include one or more pumps and throttle valves utilized to evacuate and regulate the pressure of the interior volume 106 of the processing chamber 100.

The showerhead 130 may be supported on the sidewall 108 of the chamber body 102. The showerhead 130 (or lid) may be opened to allow access to the interior volume 106 of the processing chamber 100, and may provide a seal for the processing chamber 100 while closed. A gas panel 158 may be coupled to the processing chamber 100 to provide process and/or cleaning gases to the interior volume 106 through the showerhead 130 or lid and nozzle. Showerhead 130 may be used for processing chambers used for dielectric etch (etching of dielectric materials). The showerhead 130 includes a gas distribution plate (GDP) 133 having multiple gas delivery holes 132 throughout the GDP 133. The showerhead 130 may include the GDP 133 bonded to an aluminum base or an anodized aluminum base 104. The GDP 133 may be made from Si or SiC, or may be a ceramic such as Y₂O₃, Al₂O₃, YAG, and so forth.

For processing chambers used for conductor etch (etching of conductive materials), a lid may be used rather than a showerhead. The lid may include a center nozzle that fits into a center hole of the lid. The lid may be a ceramic such as Al₂O₃, Y₂O₃, YAG, or a ceramic compound composed of Y₄Al₂O₉ and a solid-solution of Y₂O₃—ZrO₂. The nozzle may also be a ceramic, such as Y₂O₃, YAG, or the ceramic compound composed of Y₄Al₂O₉ and a solid-solution of Y₂O₃—ZrO₂. The lid, showerhead base 104, GDP 133 and/or nozzle may be coated with a ceramic coating.

Examples of processing gases that may be used to process substrates in the processing chamber 100 include halogen-containing gases, such as C₂F₆, SF₆, SiCl₄, HBr, NF₃, CF₄, CHF₃, CH₂F₃, F, NF₃, Cl₂, CCl₄, BCl₃ and SiF₄, among others, and other gases such as O₂, or N₂O. The coating layer may be resistant to erosion from some or all of these gases and/or plasma generated from these gases. Examples of carrier gases include N₂, He, Ar, and other gases inert to process gases (e.g., non-reactive gases). The substrate support assembly 148 is disposed in the interior volume 106 of the processing chamber 100 below the showerhead 130 or lid. The substrate support assembly 148 holds the substrate 144 during processing. A ring 146 (e.g., a single ring) may cover a portion of the electrostatic chuck 150, and may protect the covered portion from exposure to plasma during processing. The ring 146 may be silicon or quartz in one embodiment.

An inner liner 118 may be coated on the periphery of the substrate support assembly 148. The inner liner 118 may be a halogen-containing gas resistant material such as those discussed with reference to the outer liner 116. In one embodiment, the inner liner 118 may be fabricated from the same materials of the outer liner 116. Additionally, the inner liner 118 may be coated with a ceramic coating.

In one embodiment, the substrate support assembly 148 includes a mounting plate 162 supporting a pedestal 152, and an electrostatic chuck 150. The electrostatic chuck 150 further includes a thermally conductive base 164 and an electrostatic puck 166 bonded to the thermally conductive base by a bond 138, which may be a silicone bond in one embodiment. An upper surface of the electrostatic puck 166 is covered by the ceramic coating layer 136 in the illustrated embodiment. In one embodiment, the ceramic coating layer 136 is disposed on the upper surface of the electrostatic puck 166. In another embodiment, the ceramic coating layer 136 is disposed on the entire exposed surface of the electrostatic chuck 150 including the outer and side periphery of the thermally conductive base 164 and the electrostatic puck 166. The mounting plate 162 is coupled to the bottom 110 of the chamber body 102 and includes passages for routing utilities (e.g., fluids, power lines, sensor leads, etc.) to the thermally conductive base 164 and the electrostatic puck 166.

The thermally conductive base 164 and/or electrostatic puck 166 may include one or more optional embedded heating elements 176, embedded thermal isolators 174 and/or conduits 168, 170 to control a lateral temperature profile of the support assembly 148. The conduits 168, 170 may be fluidly coupled to a fluid source 172 that circulates a temperature regulating fluid through the conduits 168, 170. The embedded isolator 174 may be disposed between the conduits 168, 170 in one embodiment. The heater 176 is regulated by a heater power source 178. The conduits 168, 170 and heater 176 may be utilized to control the temperature of the thermally conductive base 164, thus heating and/or cooling the electrostatic puck 166 and a substrate (e.g., a wafer) 144 being processed. The temperature of the electrostatic puck 166 and the thermally conductive base 164 may be monitored using a plurality of temperature sensors 190, 192, which may be monitored using a controller 195.

The electrostatic puck 166 may further include multiple gas passages such as grooves, mesas and other surface features, which may be formed in an upper surface of the puck 166 and/or the ceramic coating layer 136. The gas passages may be fluidly coupled to a source of a heat transfer (or backside) gas such as helium via holes drilled in the puck 166. In operation, the backside gas may be provided at controlled pressure into the gas passages to enhance the heat transfer between the electrostatic puck 166 and the substrate 144. The electrostatic puck 166 includes at least one clamping electrode 180 controlled by a chucking power source 182. The electrode 180 (or other electrode disposed in the puck 166 or base 164) may further be coupled to one or more RF power sources 184, 186 through a matching circuit 188 for maintaining a plasma formed from process and/or other gases within the processing chamber 100. The sources 184, 186 are generally capable of producing an RF signal having a frequency from about 50 kHz to about 3 GHz, with a power output of up to about 10,000 Watts.

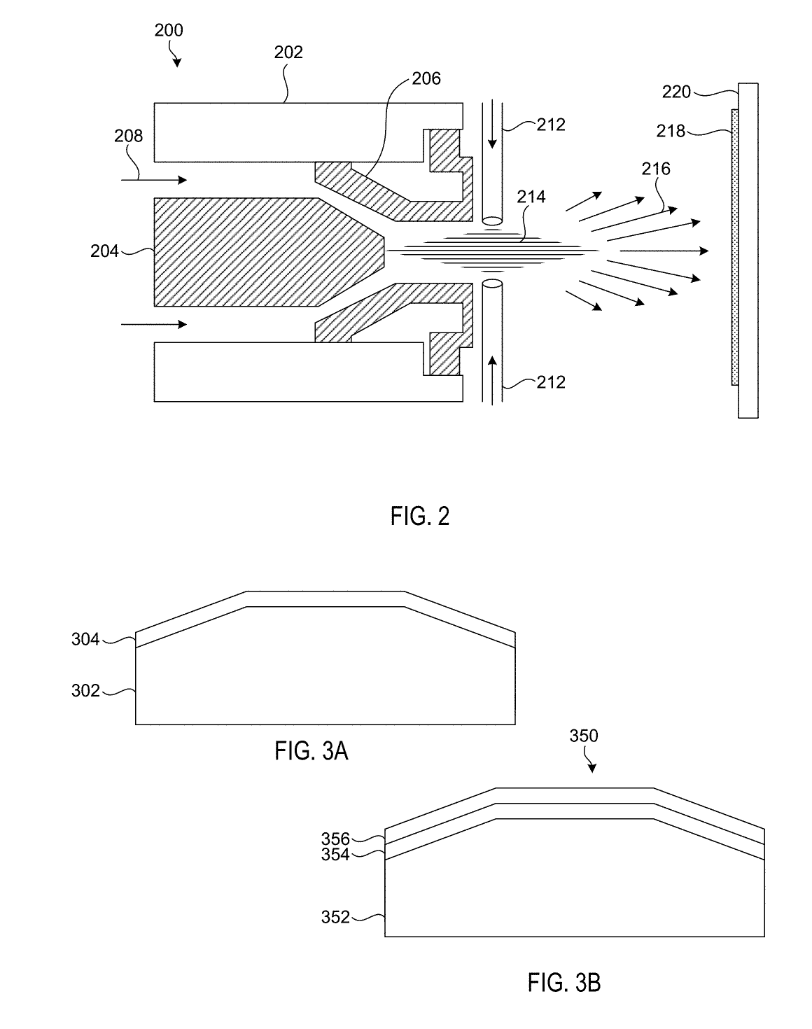

FIG. 2 depicts a sectional view of a plasma spray device 200 according to an embodiment. The plasma spray device 200 is a type of thermal spray system that may be used to perform SPPS deposition of ceramic materials. Unlike standard plasma spray techniques, SPPS deposition utilizes a solution-based distribution of metal precursor (e.g., one or more metal salts) to deposit a ceramic coating on an article. The SPPS may be performed by spraying the feedstock using atmospheric plasma spray, high velocity oxy-fuel (HVOF), warm spraying, vacuum plasma spraying (VPS), and low pressure plasma spraying (LPPS).

The plasma spray device 200 may include a casing 202 that encases a nozzle anode 206 and a cathode 204. The casing 202 permits gas flow 208 through the plasma spray device 200 and between the nozzle anode 206 and the cathode 204. An external power source may be used to apply a voltage potential between the nozzle anode 206 and the cathode 204. The voltage potential produces an arc between the nozzle anode 206 and the cathode 204 that ignites the gas flow 208 to produce a plasma gas. The ignited plasma gas flow 208 produces a high-velocity plasma plume 214 that is directed out of the nozzle anode 206 and toward an article 220. A distance between a distal end of the nozzle anode 206 and the article 220 (i.e., a gun distance) may be between about 25 mm and about 500 mm, in certain embodiments.

The plasma spray device 200 may be located in a chamber or atmospheric booth. In some embodiments, the gas flow 208 may be a gas or gas mixture including, but not limited to argon, nitrogen, hydrogen, helium, and combinations thereof. A flow rate of the gas flow 208 may be, for example, between about 20 L/min and about 1000 L/min, or between about 50 L/min and about 400 L/min A voltage potential applied between the nozzle anode 206 and the cathode 204 may be an AC waveform, a DC waveform, or a combination thereof, and may be between about 40 V and about 1000 V. The applied potential is generally capable of providing a gun power of 20 kW or greater with a gun current of up to 1000 A or greater.

The plasma spray device 200 may be equipped with one or more fluid lines 212 to deliver a feedstock solution (e.g., a metal precursor solution, etc.) into the plasma plume 214, for example, at a flow rate between 5 mL/min and about 1000 mL/min. In some embodiments, several fluid lines 212 may be arranged on one side or symmetrically around the plasma plume 214. In some embodiments, the fluid lines 212 may be arranged in a perpendicular fashion to the plasma plume 214 direction, as depicted in FIG. 2. In other embodiments, the fluid lines 212 may be adjusted to deliver the feedstock into the plasma plume at a different angle (e.g., 45°), or may be located at least partially inside of the casing 202 to internally inject the slurry into the plasma plume 214. In some embodiments, each fluid line 212 may provide a different feedstock solution, which may be utilized to vary a composition of a resulting coating across the article 220.

In certain embodiments in which the feedstock solution is a metal precursor, a solution feeder system may be utilized to deliver the solution to the fluid lines 212. In some embodiments, the solution feeder system includes a flow controller that maintains a constant flow rate during coating. The fluid lines 212 may be cleaned before and after the coating process using, for example, de-ionized water. In some embodiments, a solution container, which contains the solution fed to the plasma spray device 200, is mechanically agitated during the course of the coating process keep the solution uniform and prevent settling.

In some embodiments, the feedstock solution contains a metal precursor. In some embodiments, the metal precursor is a metal salt. In some embodiments, the metal precursor may include one or more metal salts including, but not limited to, metal nitrate, metal acetate, metal sulfate, metal chloride, metal alkoxide, or combinations thereof. In some embodiments, the metal precursor includes fluoride to form CaF₂, MgF₂, SrF₂, AlF₃, ErF₃, LaF₃, NdF₃, ScF₃, CeF₄, TiF₃, HfF₄, ZrF₄, or combinations thereof.

In some embodiments, the solvent of the feedstock solution may include a low molecular weight polar solvent, including, but not limited to, ethanol, methanol, acetonitrile, de-ionized water, or combinations thereof.

The plasma plume 214 can reach temperatures between about 3000° C. to about 10000° C. The intense temperature experienced by the feedstock solution when injected into the plasma plume 214 may cause the solvent to undergo rapid evaporation, generating a stream 216 that is propelled toward the article 220. Upon impact with the article 220, the precursor may pyrolyze in situ and rapidly solidify on the article, forming a ceramic coating 218. The solvent may be completely evaporated prior to the precursor reaching the article 220.

The parameters that can affect the thickness, density, and roughness of the ceramic coating include the feedstock solution conditions, the concentrations of amounts and relative quantities of different metal precursors, the feed rate, the plasma gas composition, the gas flow rate, the energy input, the spray distance, and article temperature during deposition.

FIGS. 3A and 3B depict a sectional view of an exemplary chamber component with one and two coatings, respectively, according to an embodiment. Referring to FIG. 3A, at least a portion of a base or body 302 of an article 300 is coated by a ceramic coating 304. The article 300 may be the same as the article 220 described with respect to FIG. 2) may be a chamber component, such as a substrate support assembly, an electrostatic chuck (ESC), a ring (e.g., a process kit ring or single ring), a chamber liner, a showerhead base, a gas distribution plate, a liner, a liner kit, a shield, a plasma screen, a flow equalizer, a cooling base, a chamber viewport, a chamber lid, and so on. The body 302 of the article 300 may be a metal, a ceramic, a metal-ceramic composite, a polymer, or a polymer-ceramic composite.

Various chamber components are composed of different materials. For example, an electrostatic chuck may be composed of a ceramic such as Al₂O₃ (alumina), AlN (aluminum nitride), TiO (titanium oxide), TiN (titanium nitride) or SiC (silicon carbide) bonded to an anodized aluminum base. Al₂O₃, AlN and anodized aluminum have poor plasma erosion resistance. When exposed to a plasma environment with a fluorine chemistry and/or reducing chemistry, an electrostatic puck of an electrostatic chuck may exhibit degraded wafer chucking, increased helium leakage rate, wafer front-side and back-side particle production and on-wafer metal contamination after about 50 radio frequency hours (RFHrs) of processing. A radio frequency hour is an hour of processing.

A lid for a plasma etcher used for conductor etch processes may be a sintered ceramic such as Al₂O₃ since Al₂O₃ has a high flexural strength and high thermal conductivity. However, Al₂O₃ exposed to fluorine chemistries forms AlF particles as well as aluminum metal contamination on wafers. Some chamber lids have a thick film protective layer on a plasma facing side to minimize particle generation and metal contamination and to prolong the life of the lid. However, most thick film coating techniques inherent cracks and pores that might degrade on-wafer defect performance.

A process kit ring and a single ring may be used to seal and/or protect other chamber components, and are typically manufactured from quartz or silicon. These rings may be disposed around a supported substrate (e.g., a wafer) to ensure a uniform plasma density (and thus uniform etching). However, quartz and silicon have very high erosion rates under various etch chemistries (e.g., plasma etch chemistries). Additionally, such rings may cause particle contamination when exposed to plasma chemistries. The process kit ring and single ring may also consist of sintered ceramics such as YAG and or a ceramic compound composed of Y₄Al₂O₉ and a solid-solution of Y₂O₃—ZrO₂.

The showerhead for an etcher used to perform dielectric etch processes is typically made of anodized aluminum bonded to a SiC faceplate. When such a showerhead is exposed to plasma chemistries including fluorine, AlF may form due to plasma interaction with the anodized aluminum base. Additionally, a high erosion rate of the anodized aluminum base may lead to arcing and ultimately reduce a mean time between cleaning for the showerhead.

A chamber viewport (also known as an endpoint window) is a transparent component typically made of quartz or sapphire. Various optical sensors may be protected by the viewport, and may make optical sensor readings through the viewport. Additionally, a viewport may enable a user to visually inspect or view wafers during processing. Both quartz and sapphire have poor plasma erosion resistance. As the plasma chemistry erodes and roughens the viewport, the optical properties of the viewport change. For example, the viewport may become cloudy and/or an optical signal passing through the viewport may become skewed. This may impair an ability of the optical sensors to collect accurate readings. However, thick film protective layers may be inappropriate for use on the viewport because these coatings may occlude the viewport.

The examples provided above set forth just a few chamber components whose performance may be improved by use of a thin film protective layer as set forth in embodiments herein.

Referring back to FIG. 3A, a body 302 of the article 300 may include one or more surface features. For an electrostatic chuck, surface features may include mesas, sealing bands, gas channels, helium holes, and so forth. For a showerhead, surface features may include a bond line, hundreds or thousands of holes for gas distribution, divots or bumps around gas distribution holes, and so forth. Other chamber components may have other surface features.

The ceramic coating 304 formed on the body 302 may conform to the surface features of the body 302. As shown, the ceramic coating 304 maintains a relative shape of the upper surface of the body 302 (e.g., telegraphing the shapes of the mesa). Additionally, the ceramic coating may be thin enough so as not to plug holes in the showerhead or helium holes in the electrostatic chuck. In one embodiment, the ceramic coating 304 has a thickness of below about 20 micrometers, or below about 10 micrometers. In a further embodiment, the ceramic coating 304 has a thickness of between about 10 micrometers to about 500 micrometers. The ceramic coating 304 may be deposited on the body 302 using the plasma spray device 200 described with respect to FIG. 2.

Referring to FIG. 3B, at least a portion of a base or body 352 of an article 350 is coated with two coatings: a first coating 354 and a second coating 356 deposited on the first coating 354. In some embodiments, the first coating 354 may be a coating performed using a standard deposition technique, such as dry plasma spraying of a powder, thermal deposition, sputtering, etc. The first coating 354 may be a ceramic coating, but may have high surface roughness as well as surface defects such as cracks and pores. Accordingly, the second coating 356 may be deposited onto the first coating 354. The second coating may be an SPPS-deposited ceramic coating using, for example, the plasma spray device 200 described with respect to FIG. 2. In some embodiments, the first and second coating may both be SPPS-deposited ceramic coatings with different compositions.

The first and second coatings 354, 356 are merely illustrative, and any suitable number of coatings may be deposited on the body 352, forming a coating stack. One or more of the coatings in the coating stack may be a ceramic coating (e.g., an SPPS-deposited ceramic coating). The coatings in the coating stack may all have the same thickness, or they may have varying thicknesses. Each of the coatings in the coating stack may have a thickness of less than about 20 micrometers, and about 10 micrometers in some embodiments. In one example, for the two-layer stacking, as depicted in FIG. 3B, the first coating 354 may have a thickness of about 10 micrometers, and the second coating 356 may have a thickness of about 10 micrometers. In another example, first coating 356 may be a YAG layer having a thickness of about 10 micrometers, and the second coating 356 may be an SPPS-deposited ceramic coating having a thickness of about 500 micrometers.

Each time the article is heated and cooled, the mismatch in coefficients of thermal expansion between a ceramic coating and the article that it coats cause stress on ceramic coating. Such stress may be concentrated at the vertical cracks. This may cause the ceramic coating to eventually peel away from the article that it coats. In contrast, if there are not vertical cracks, then the stress is approximately evenly distributed across the thin film. Accordingly, in one embodiment the first coating 354 is an amorphous ceramic such as YAG or EAG, and the second coating 356 is a crystalline or nano-crystalline ceramic such as the ceramic compound or Er₂O₃, in which one or more of the coatings are SPPS-deposited coatings. In such an embodiment, the second coating 356 may provide greater plasma resistance as compared to the first coating 354. By forming the second coating 356 over the first coating 354 rather than directly over the body 352, the first coating 354 acts as a buffer to minimize lattice mismatch on the subsequent coating. Thus, a lifetime of the second coating 356 may be increased.

In another example, each of the body and one or more coatings may have a different coefficient of thermal expansion. The greater the mismatch in the coefficient of thermal expansion between two adjacent materials, the greater the likelihood that one of those materials will eventually crack, peel away, or otherwise lose its bond to the other material. The first and second coatings 354, 356 may be formed in such a way to minimize mismatch of the coefficient of thermal expansion between adjacent coatings (or between the first coating 354 and the body 352). For example, the body 352 may be alumina, and EAG may have a coefficient of thermal expansion that is closest to that of alumina, followed by the coefficient of thermal expansion for YAG, followed by the coefficient of thermal expansion for an additional compound ceramic coating. Accordingly, first coating 354 may be EAG, the second coating 356 may be YAG, and an additional coating may be the compound ceramic in one embodiment.

In another example, the coatings in the coating stack may be alternating layers of two different ceramics. For example, a first and third coating may be YAG, and a second and fourth coating may be the compound ceramic. Such alternating coatings may provide advantages similar to those set forth above in cases where one material used in the alternating coatings is amorphous and the other material used in the alternating coatings is crystalline or nano-crystalline.

In some embodiments, one of more of the coatings in the coating stack are transition layers formed using a heat treatment. If the body 352 is a ceramic body, then a high temperature heat treatment may be performed to promote interdiffusion between a ceramic coating (e.g., ceramic coating 354) and the body 352. Additionally, the heat treatment may be performed to promote interdiffusion between adjacent coatings or between a thick coating and a thin coating. The transition layer may be a non-porous layer, may act as a diffusion bond between two ceramics, and may provide improved adhesion between the adjacent ceramic coatings. This may help prevent a ceramic coating from cracking, peeling off, or stripping off during plasma processing.

By performing SPPS deposition using solution containing a metal precursor, in accordance with the embodiments described herein, examples of ceramic coating compositions may include Y₃Al₅O₁₂, Y₄Al₂O₉, Er₂O₃, Gd₂O₃, La₂O₃, YAG, Er₃Al₅O₁₂, Gd₃Al₅O₁₂, YF₃, Y₂O₃, YOF, a ceramic compound composed of Y₄Al₂O₉ and a solid-solution of Y₂O₃—ZrO₂ (Y₂O₃—ZrO₂ solid solution), or any of the other ceramic materials previously identified. Other Er based and/or Gd based plasma resistant rare earth oxides may also be used to form the ceramic coatings (e.g., coatings 218, 304, 354, and/or 356).

The SPPS-deposited ceramic coatings may also be based on a solid solution formed by any of the aforementioned ceramics. With reference to the ceramic compound composed of Y₄Al₂O₉ and a solid-solution of Y₂O₃—ZrO₂, in one embodiment, the ceramic compound includes 62.93 molar ratio (mol %) Y₂O₃, 23.23 mol % ZrO₂ and 13.94 mol % Al₂O₃.

In another embodiment, the ceramic compound can include Y₂O₃ in a range of 50-75 mol %, ZrO₂ in a range of 10-30 mol % and Al₂O₃ in a range of 10-30 mol %.

In another embodiment, the ceramic compound can include Y₂O₃ in a range of 40-100 mol %, ZrO₂ in a range of 0-60 mol % and Al₂O₃ in a range of 0-10 mol %.

In another embodiment, the ceramic compound can include Y₂O₃ in a range of 60-75 mol %, ZrO₂ in a range of 20-30 mol % and Al₂O₃ in a range of 0-5 mol %.

In another embodiment, the ceramic compound can include Y₂O₃ in a range of 60-70 mol %, ZrO₂ in a range of 30-40 mol % and Al₂O₃ in a range of 0-10 mol %.

In another embodiment, the ceramic compound can include Y₂O₃ in a range of 50-60 mol % and ZrO₂ in a range of 40-50 mol %.

In another embodiment, the ceramic compound can include Y₂O₃ in a range of 40-60 mol %, ZrO₂ in a range of 30-50 mol % and Al₂O₃ in a range of 10-20 mol %.

In another embodiment, the ceramic compound can include Y₂O₃ in a range of 40-50 mol %, ZrO₂ in a range of 20-40 mol % and Al₂O₃ in a range of 20-40 mol %.

In another embodiment, the ceramic compound can include Y₂O₃ in a range of 70-90 mol %, ZrO₂ in a range of 0-20 mol % and Al₂O₃ in a range of 10-20 mol %.

In another embodiment, the ceramic compound can include Y₂O₃ in a range of 60-80 mol %, ZrO₂ in a range of 0-10 mol % and Al₂O₃ in a range of 20-40 mol %.

In another embodiment, the ceramic compound can include Y₂O₃ in a range of 40-60 mol %, ZrO₂ in a range of 0-20 mol % and Al₂O₃ in a range of 30-40 mol %.

In another embodiment, the ceramic compound can include Y₂O₃ in a range of 30-60 mol %, ZrO₂ in a range of 0-20 mol % and Al₂O₃ in a range of 30-60 mol %.

In another embodiment, the ceramic compound can include Y₂O₃ in a range of 20-40 mol %, ZrO₂ in a range of 20-80 mol % and Al₂O₃ in a range of 0-60 mol %.

In another embodiment, the ceramic compound can include Y₂O₃ in a range of 0-10 mol %, ZrO₂ in a range of 20-30 mol % and Al₂O₃ in a range of 50-60 mol %.

In another embodiment, the ceramic compound can include Y₂O₃ in a range of 0-10 mol %, ZrO₂ in a range of 20-30 mol % and Al₂O₃ in a range of 40-50 mol %.

In another embodiment, the ceramic compound can include Y₂O₃ in a range of 0-10 mol %, ZrO₂ in a range of 10-20 mol % and Al₂O₃ in a range of 50-60 mol %.

In another embodiment, the ceramic compound can include Y₂O₃ in a range of 0-10 mol %, ZrO₂ in a range of 10-20 mol % and Al₂O₃ in a range of 40-50 mol %.

In another embodiment, the ceramic compound can include Y₂O₃ in a range of 10-20 mol %, ZrO₂ in a range of 20-30 mol % and Al₂O₃ in a range of 50-60 mol %.

In another embodiment, the ceramic compound can include Y₂O₃ in a range of 10-20 mol %, ZrO₂ in a range of 20-30 mol % and Al₂O₃ in a range of 40-50 mol %.

In another embodiment, the ceramic compound can include Y₂O₃ in a range of 10-20 mol %, ZrO₂ in a range of 10-20 mol % and Al₂O₃ in a range of 50-60 mol %.

In another embodiment, the ceramic compound can include Y₂O₃ in a range of 10-20 mol %, ZrO₂ in a range of 10-20 mol % and Al₂O₃ in a range of 40-50 mol %.

In another embodiment, the ceramic compound can include Y₂O₃ in a range of 0-10 mol %, ZrO₂ in a range of 40-50 mol % and Al₂O₃ in a range of 10-20 mol %.

In another embodiment, the ceramic compound can include Y₂O₃ in a range of 0-10 mol %, ZrO₂ in a range of 40-50 mol % and Al₂O₃ in a range of 20-30 mol %.

In another embodiment, the ceramic compound can include Y₂O₃ in a range of 0-10 mol %, ZrO₂ in a range of 50-60 mol % and Al₂O₃ in a range of 10-20 mol %.

In another embodiment, the ceramic compound can include Y₂O₃ in a range of 0-10 mol %, ZrO₂ in a range of 50-60 mol % and Al₂O₃ in a range of 20-30 mol %.

In another embodiment, the ceramic compound can include Y₂O₃ in a range of 10-20 mol %, ZrO₂ in a range of 40-50 mol % and Al₂O₃ in a range of 10-20 mol %.

In another embodiment, the ceramic compound can include Y₂O₃ in a range of 10-20 mol %, ZrO₂ in a range of 40-50 mol % and Al₂O₃ in a range of 20-30 mol %.

In another embodiment, the ceramic compound can include Y₂O₃ in a range of 10-20 mol %, ZrO₂ in a range of 50-60 mol % and Al₂O₃ in a range of 10-20 mol %.

In another embodiment, the ceramic compound can include Y₂O₃ in a range of 10-20 mol %, ZrO₂ in a range of 50-60 mol % and Al₂O₃ in a range of 20-30 mol %.

In other embodiments, other distributions may also be used for the ceramic compound.

In one embodiment, an alternative ceramic compound that includes a combination of Y₂O₃, ZrO₂, Er₂O₃, Gd₂O₃ and SiO₂ is used for the ceramic coating.

In one embodiment, the alternative ceramic compound can include Y₂O₃ in a range of 40-45 mol %, ZrO₂ in a range of 0-10 mol %, Er₂O₃ in a range of 35-40 mol %, Gd₂O₃ in a range of 5-10 mol % and SiO2 in a range of 5-15 mol %.

In another embodiment, the alternative ceramic compound can include Y₂O₃ in a range of 30-60 mol %, ZrO₂ in a range of 0-20 mol %, Er₂O₃ in a range of 20-50 mol %, Gd₂O₃ in a range of 0-10 mol % and SiO2 in a range of 0-30 mol %.

In another embodiment, the alternative ceramic compound can include Y₂O₃ in a range of 30-45 mol %, ZrO₂ in a range of 5-15% mol %, Er₂O₃ in a range of 25-60 mol % and Gd₂O₃ in a range of 0-25 mol %.

In another embodiment, the alternative ceramic compound can include Y₂O₃ in a range of 0-100 mol % and YF₃ in a range of 0-100 mol %.

In another embodiment, the alternative ceramic compound can include Y₂O₃ in a range of 1-99 mol % and YF₃ in a range of 1-99 mol %.

In another embodiment, the alternative ceramic compound can include Y₂O₃ in a range of 1-10 mol % and YF₃ in a range of 90-99 mol %.

In another embodiment, the alternative ceramic compound can include Y₂O₃ in a range of 11-20 mol % and YF₃ in a range of 80-89 mol %.

In another embodiment, the alternative ceramic compound can include Y₂O₃ in a range of 21-30 mol % and YF₃ in a range of 70-79 mol %.

In another embodiment, the alternative ceramic compound can include Y₂O₃ in a range of 31-40 mol % and YF₃ in a range of 60-69 mol %.

In another embodiment, the alternative ceramic compound can include Y₂O₃ in a range of 41-50 mol % and YF₃ in a range of 50-59 mol %.

In another embodiment, the alternative ceramic compound can include Y₂O₃ in a range of 51-60 mol % and YF₃ in a range of 40-49 mol %.

In another embodiment, the alternative ceramic compound can include Y₂O₃ in a range of 61-70 mol % and YF₃ in a range of 30-39 mol %.

In another embodiment, the alternative ceramic compound can include Y₂O₃ in a range of 71-80 mol % and YF₃ in a range of 20-29 mol %.

In another embodiment, the alternative ceramic compound can include Y₂O₃ in a range of 81-90 mol % and YF₃ in a range of 10-19 mol %.

In another embodiment, the alternative ceramic compound can include Y₂O₃ in a range of 91-99 mol % and YF₃ in a range of 1-9 mol %.

It is to be understood that, for the various embodiments described herein, the mol % ranges are to add up to 100 mol %, and may include other materials in mol % that collectively add up to 100 mol % unless otherwise indicated. An embodiment that includes, for example, Y₂O₃ in a range of 91-99 mol % and YF₃ in a range of 1-9 mol % may be satisfied by a composition including 95% mol % of Y₂O₃ and 5 mol % of YF₃, and may also be satisfied by a composition including 91 mol % of Y₂O₃, 5 mol % of YF₃, and 4 mol % of any other material.

Examples of specific compositions now follow. In one example, the alternative ceramic compound includes 40 mol % Y₂O₃, 5 mol % ZrO₂, 35 mol % Er₂O₃, 5 mol % Gd₂O₃ and 15 mol % SiO₂.

In a further example, the alternative ceramic compound includes 45 mol % Y₂O₃, 5 mol % ZrO₂, 35 mol % Er₂O₃, 10 mol % Gd₂O₃ and 5 mol % SiO₂.

In a further example, the alternative ceramic compound includes 40 mol % Y₂O₃, 5 mol % ZrO₂, 40 mol % Er₂O₃, 7 mol % Gd₂O₃ and 8 mol % SiO₂.

In a further example, the ceramic coating is a material entitled YEZ08 that includes 37 mol % Y₂O₃, 8 mol % ZrO₂ and 55 mol % Er₂O₃.

In a further example, the ceramic coating is a material entitled YEZG10 that includes 40 mol % Y₂O₃, 10 mol % ZrO₂, 30 mol % Er₂O₃ and 20 mol % Gd₂O₃.

In a further example, the coating may include 73.13 mol % Y₂O₃ and 26.87 mol % ZrO₂ and may be referred to as YZ20.

In a further example, the coating may include 71.96 mol % Y₂O₃, 26.44 mol % ZrO₂, and 1.6 mol % Al₂O₂.

In a further example, the coating may include 64.46 mol % Y₂O₃ and 35.54 mol % ZrO₂.

In a further example, the coating may include 63.56 mol % Y₂O₃, 35.03 mol % ZrO₂, and 1.41 mol % Al₂O₂.

In a further example, the coating may include 57.64 mol % Y₂O₃ and 42.36 mol % ZrO₂.

In a further example, the coating may include 52.12 mol % Y₂O₃ and 47.88 mol % ZrO₂.

In a further example, the coating may include 40 mol % Y₂O₃, 5 mol % ZrO₂, 35 mol % Er₂O₃, 5 mol % Gd₂O₂, and 15 mol % SiO₂.

In a further example, the coating may include 45 mol % Y₂O₃, 5 mol % ZrO₂, 35 mol % Er₂O₃, 10 mol % Gd₂O₂, and 5 mol % SiO₂.

In a further example, the coating may include 40 mol % Y₂O₃, 5 mol % ZrO₂, 40 mol % Er₂O₃, 7 mol % Gd₂O₂, and 8 mol % SiO₂.

In a further example, the coating may include 50 mol % Y₂O₃ and 50 mol % YF₃.

Any of the aforementioned ceramic coatings may include trace amounts of other materials such as ZrO₂, Al₂O₃, SiO₂, B₂O₃, Er₂O₃, Nd₂O₃, Nb₂O₅, CeO₂, Sm₂O₃, Yb₂O₃, or other oxides. In one embodiment, the same ceramic material is not used for two adjacent ceramic coatings. However, in another embodiment adjacent coatings may be composed of the same ceramic.

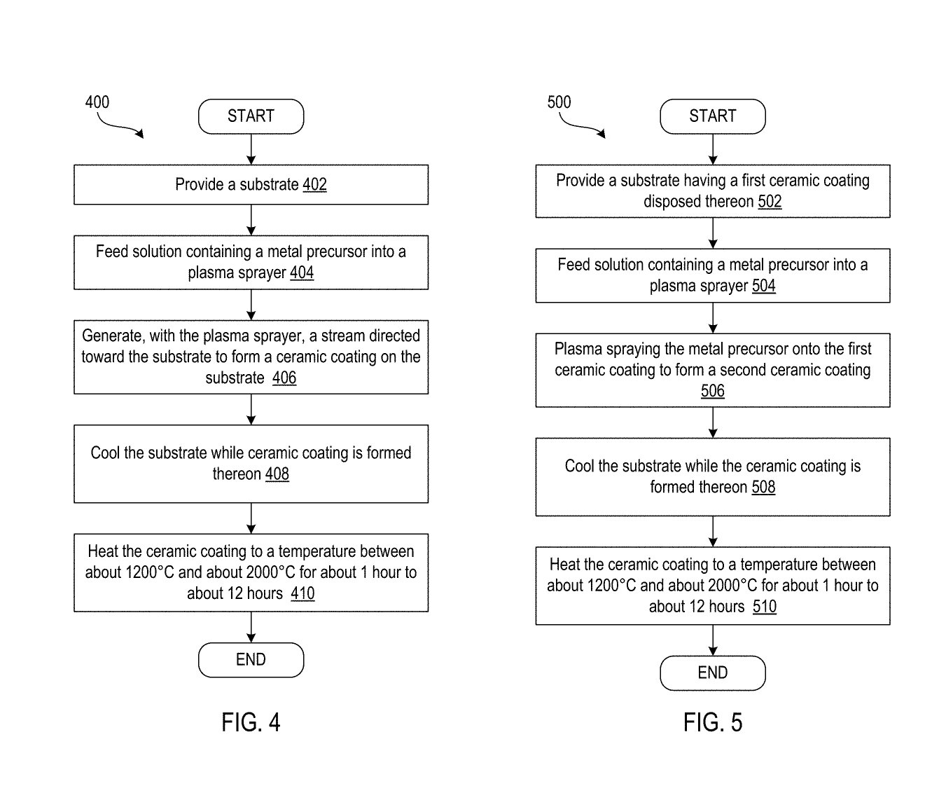

FIG. 4 is a flow diagram illustrating a process 400 for producing a coating in accordance with an embodiment. At block 402, an article is provided. In some embodiments, the article is a wafer (e.g., a silicon wafer substrate). In some embodiments, the article may be a suitable chamber component as described with respect to FIG. 1. For example, the article could be any of, but not limited to, a lid, a nozzle, an electrostatic chuck (e.g., ESC 150), a showerhead (e.g., showerhead 130), a liner (e.g., outer liner 116 or inner liner 118) or liner kit, or a ring (e.g., ring 146).

At block 404, a solution containing one or more metal precursors is fed into a plasma sprayer. The solution may be fed into the plasma sprayer (e.g., the plasma spray device 200) using a suitable fluid line (e.g., one or more of the fluid lines 212).

At block 406, the plasma sprayer generates a stream directed toward the article to form a ceramic coating on the article. As the solution enters a plasma plume generated by the plasma sprayer (e.g., plasma plume 214), the solvent is vaporized a stream of metal precursor is propelled toward the article (e.g., article 220). The precursor pyrolyzes during impact with a surface of the article to form a ceramic coating thereon. A composition of the resultant ceramic coating may be one or more of Y₃Al₅O₁₂, Y₄Al₂O₉, Er₂O₃, Gd₂O₃, Gd₃Al₅O₁₂ (GAG), YF₃, Y₂O₃, YOF, Nd₂O₃, Er₄Al₂O₉, Er₃Al₅O₁₂ (EAG), ErAlO₃, Gd₄Al₂O₉, GdAlO₃, Nd₃Al₅O₁₂, Nd₄Al₂O₉, NdAlO₃, a ceramic compound composed of Y₄Al₂O₉ and a solid-solution of Y₂O₃—ZrO₂, or any other coating composition described herein.

In some embodiments, a mask may have been placed over the article prior to performing SPPS deposition. For example, a mask may be placed a short distance from the article (e.g., 1-10 mm) that selectively blocks the stream from contacting certain regions of the article. As another example, the mask may be a photoresist layer, which can be stripped later to leave behind features composed of ceramic material on the article. The masking may allow for macroscale and microscale ceramic features to be deposited on the article. For example, masking the article may be used to form mesas on ESC surfaces.

At block 408, the article is cooled while the ceramic coating is formed thereon. For example, a cooling fluid line (e.g., a water line) may pass beneath or adjacent to the article in order to induce heat exchange between the article and the cooling fluid as the hot stream contacts the article. Cooling the article may facilitate the formation of a ceramic coating in some embodiments. In other embodiments, block 408 may be omitted entirely.

At block 410, the ceramic coating is heated to a temperature between about 1200° C. and about 2000° C. for about 1 hour to about 12 hours. In some embodiments, block 410 is performed after the SPPS deposition is completed. The article may be heated in the plasma sprayer chamber (e.g., by heating with a thermal element located adjacent to the article) or in a separate heating chamber. Heating the ceramic coating may help to reduce the porosity and surface roughness of the ceramic coating. In some embodiments, block 410 may be omitted entirely. As used herein, “surface roughness” in units of μin refers to an R_{z} surface profile, unless otherwise specified. In some embodiments, a surface roughness of the ceramic coating is less than or equal to 300 μin. In some embodiments, a surface roughness of the ceramic coating is less than or equal to 250 μin. In some embodiments, a surface roughness of the ceramic coating is less than or equal to 150 μin. In some embodiments, the surface roughness of the ceramic coating is less than or equal to 100 μin. In some embodiments, the surface roughness of the ceramic coating is from 50 μin to 150 μin. In some embodiments, the surface roughness of the ceramic coating is from 50 μin to 100 μin.

FIG. 5 is a flow diagram illustrating a process 500 for producing a multilayered coating in accordance with an embodiment. At block 502, an article having a first ceramic coating disposed thereon is provided. The first ceramic coating may be an SPPS-deposited coating, or may have been deposited using a different deposition technique. In some embodiments, the article may be a suitable chamber component as described with respect to FIG. 1. For example, the article could be any of, but not limited to, a lid, a nozzle, an electrostatic chuck (e.g., ESC 150), a showerhead (e.g., showerhead 130), a liner (e.g., outer liner 116 or inner liner 118) or liner kit, or a ring (e.g., ring 146).

At block 504, a solution containing one or more metal precursors is fed into a plasma sprayer. Block 504 may be the same or similar to block 404 described with respect to FIG. 4. At block 506, the plasma sprayer generates a stream directed toward the article to form a second ceramic coating on the first ceramic coating. Block 506 may be the same or similar to block 406 described with respect to FIG. 4, and the solution may be any suitable solution described herein. In some embodiments, a first porosity of the first ceramic coating is greater than 1.5%, and a second porosity of the second ceramic coating is less than or equal to 5%. In some embodiments, the second porosity is less than or equal to 4%. In some embodiments, the second porosity is less than or equal to 3%. In some embodiments, the second porosity is less than or equal to 2%. In some embodiments, the second porosity is less than or equal to 1.5%. In some embodiments, a first surface roughness of the first ceramic coating is greater than or equal to 150 μin, and a second surface roughness of the second ceramic coating is less than or equal to 300 μin. In some embodiments, the surface roughness of the second ceramic coating is less than or equal to 250 μin. In some embodiments, the surface roughness of the second ceramic coating is less than or equal to 150 μin. In some embodiments, the surface roughness of the second ceramic coating is less than or equal to 100 μin. In some embodiments, the surface roughness of the second ceramic coating is from 50 μin to 300 μin. In some embodiments, the surface roughness of the second ceramic coating is from 50 μin to 100 μin. In some embodiments, masking (as described with respect to block 406 in FIG. 4) may be used to selectively pattern ceramic features on the first ceramic coating.

In some embodiments, the first and second ceramic coatings have the same compositions. In some embodiments, the first and second ceramic coatings have different compositions. In some embodiments, blocks 504 and 506 may be performed as many times as desired to produce a multilayered coating stack.

At block 508, the article is cooled while the ceramic coating is formed thereon. Block 508 may be performed in a substantially similar fashion as block 408, as described with respect to FIG. 4. In some embodiments, block 508 may be omitted entirely.

At block 510, the ceramic coating is heated to a temperature between about 1200° C. and about 2000° C. for about 1 hour to about 12 hours. Block 510 may be performed in a substantially similar fashion as block 410, as described with respect to FIG. 4. In some embodiments, block 510 may be omitted entirely.

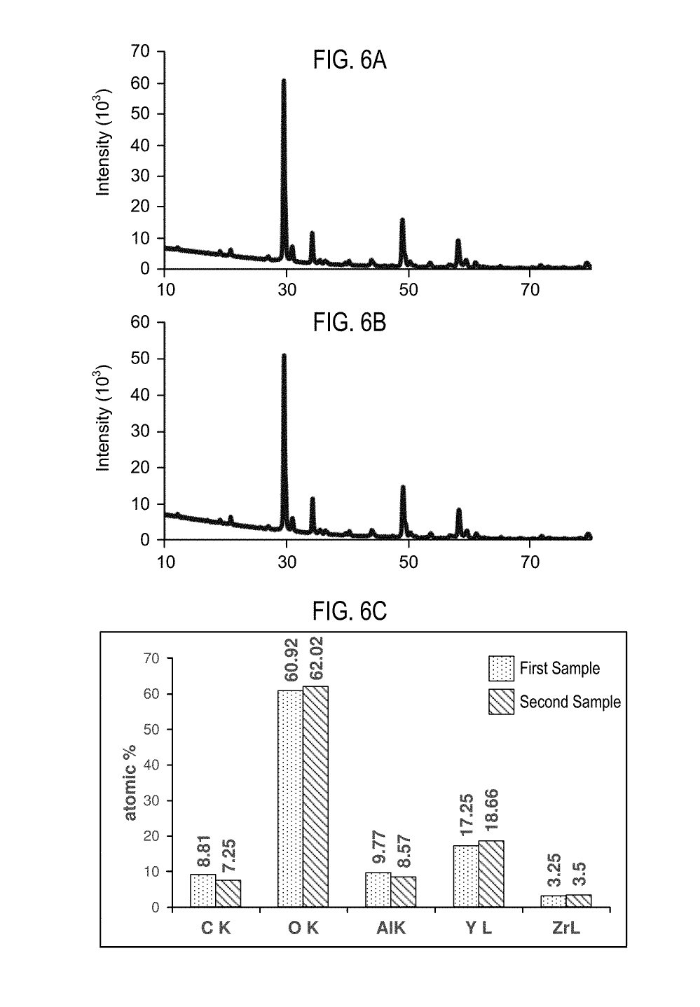

In accordance with certain embodiments, two coating samples were prepared and characterized. X-ray diffraction spectra for both the first and second coating samples, shown in FIGS. 6A and 6B, respectively, show peaks indicative of a Y₂O₃ solid solution. FIG. 6C is a graph of elemental analysis data showing the atomic ratios of various elements for the first and second coating samples.

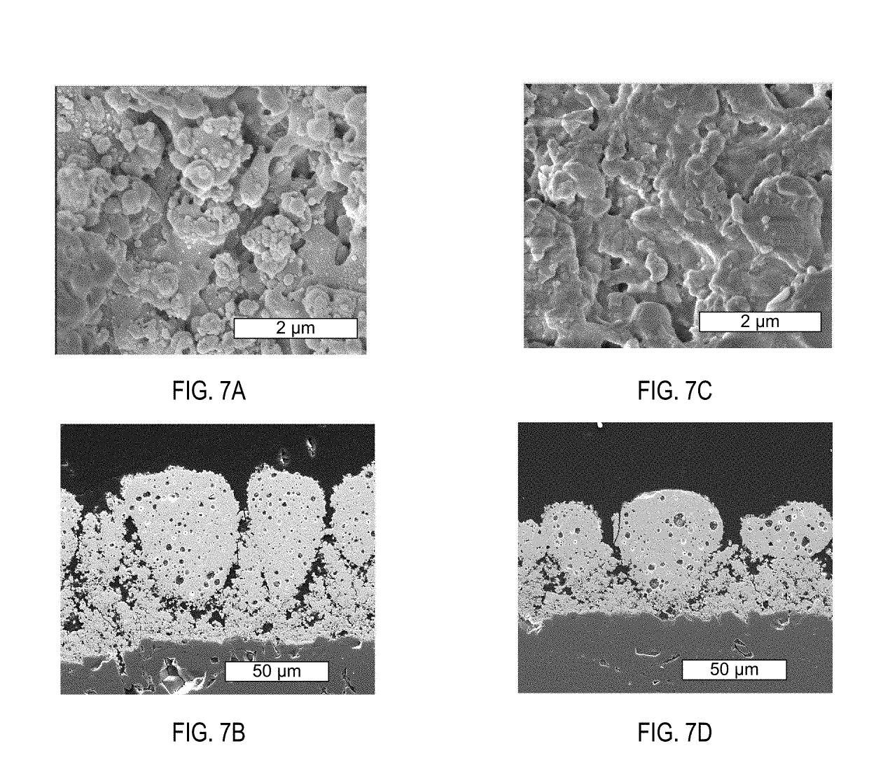

Surface morphology characterization was performed for surface imaging and roughness measurements of the first and second coating samples. Top-down and cross-sectional electron micrographs for the first coating sample are shown in FIGS. 7A and 7B, respectively, and top-down and cross-sectional electron micrographs for the second coating sample are shown in FIGS. 7C and 7D, respectively. Atomic force microscopy was used to measure the surface roughness. An R_{z} surface roughness of 92.97 μm and an Rₐ surface roughness of 5.88 μm were measured for the first coating sample, and an R_{z} surface roughness of 68.99 μm and an Rₐ surface roughness of 6.50 μm were measured for the second coating sample.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the embodiments of the present disclosure. Thus, the specific details set forth are merely exemplary. Particular embodiments may vary from these exemplary details and still be contemplated to be within the scope of the present disclosure.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. A method comprising:
providing an article;
feeding a solution into a plasma sprayer, wherein the solution comprises a metal precursor; and
generating, with the plasma sprayer, a stream directed toward the article, wherein the stream forms a ceramic coating on the article upon contact with the article, and wherein the ceramic coating comprises:
50-75 mol % of Y₂O₃, 10-30 mol % of ZrO₂, and 10-30 mol % of Al₂O₃;
40-100 mol % of Y₂O₃, 0-60 mol % of ZrO₂, and 0-10 mol % of Al₂O₃;
60-75 mol % of Y₂O₃, 20-30 mol % of ZrO₂, and 0-5 mol % of Al₂O₃;
60-70 mol % of Y₂O₃, 30-40 mol % of ZrO₂, and 0-10 mol % of Al₂O₃;
50-60 mol % of Y₂O₃ and 40-50 mol % of ZrO₂;
40-60 mol % of Y₂O₃, 30-50 mol % of ZrO₂, and 10-20 mol % of Al₂O₃;
40-50 mol % of Y₂O₃, 20-40 mol % of ZrO₂, and 20-40 mol % of Al₂O₃;
70-90 mol % of Y₂O₃, 0-20 mol % of ZrO₂, and 10-20 mol % of Al₂O₃;
60-80 mol % of Y₂O₃, 0-10 mol % of ZrO₂, and 20-40 mol % of Al₂O₃;
40-60 mol % of Y₂O₃, 0-20 mol % of ZrO₂, and 30-40 mol % of Al₂O₃;
30-60 mol % of Y₂O₃, 0-20 mol % of ZrO₂, and 30-60 mol % of Al₂O₃;
20-40 mol % of Y₂O₃, 20-80 mol % of ZrO₂, and 0-60 mol % of Al₂O₃; or
1-99 mol % Y₂O₃ and 1-99 mol % YF₃.

2. The method of claim 1, wherein the metal precursor comprises a metal salt, the metal salt comprising one or more of a metal nitrate, metal sulfate, metal acetate, metal chloride, or metal alkoxide.

3. The method of claim 1, wherein the metal precursor comprises one or more of CaF₂, MgF₂, SrF₂, AlF₃, ErF₃, LaF₃, NdF₃, ScF₃, CeF₄, TiF₃, HfF₄, or ZrF₄.

4. The method of claim 1, wherein the metal precursor comprises a yttrium metal salt, a zirconium metal salt, or an aluminum metal salt.

5. The method of claim 1, wherein the ceramic coating comprises 30-60 mol % of Y₂O₃, 0-20 mol % of ZrO₂, and 20-50 mol % of Er₂O₃, 0-10 mol % of Gd₂O₃, and 0-30 mol % of SiO₂.

6. The method of claim 1, wherein the ceramic coating comprises 30-45 mol % of Y₂O₃, 5-15% mol % of ZrO₂, 25-60 mol % of Er₂O₃, and 0-25 mol % of Gd₂O₃.

7. The method of claim 1, wherein the solution comprises at least one of ethanol, methanol, de-ionized water, or acetonitrile.

8. The method of claim 1, wherein a thickness of the ceramic coating is up to about 500 micrometers.

9. The method of claim 1, wherein a surface roughness of the ceramic coating is less than 300 μin.

10. The method of claim 1, wherein a porosity of the ceramic coating is less than about 5%.

11. The method of claim 1, wherein the article is a chamber component selected from a group comprising a lid, a nozzle, an electrostatic chuck, a showerhead, a liner kit, or a ring.

12. A method comprising:
providing an article, the article comprising a first ceramic coating disposed thereon;
feeding solution into a plasma sprayer, the solution comprising a metal precursor; and
plasma spraying the solution onto the first ceramic coating to form a second ceramic coating, wherein at least one of the first or second ceramic coatings comprises a ceramic compound comprising Y₄Al₂O₉ and a solid-solution of Y₂O₃—ZrO₂.

13. The method of claim 12, wherein at least one of the first or second ceramic coatings comprises:
50-75 mol % of Y₂O₃, 10-30 mol % of ZrO₂, and 10-30 mol % of Al₂O₃;
40-100 mol % of Y₂O₃, 0-60 mol % of ZrO₂, and 0-10 mol % of Al₂O₃;
60-75 mol % of Y₂O₃, 20-30 mol % of ZrO₂, and 0-5 mol % of Al₂O₃;
60-70 mol % of Y₂O₃, 30-40 mol % of ZrO₂, and 0-10 mol % of Al₂O₃;
50-60 mol % of Y₂O₃ and 40-50 mol % of ZrO₂;
40-60 mol % of Y₂O₃, 30-50 mol % of ZrO₂, and 10-20 mol % of Al₂O₃;
40-50 mol % of Y₂O₃, 20-40 mol % of ZrO₂, and 20-40 mol % of Al₂O₃;
70-90 mol % of Y₂O₃, 0-20 mol % of ZrO₂, and 10-20 mol % of Al₂O₃;
60-80 mol % of Y₂O₃, 0-10 mol % of ZrO₂, and 20-40 mol % of Al₂O₃;
40-60 mol % of Y₂O₃, 0-20 mol % of ZrO₂, and 30-40 mol % of Al₂O₃;
30-60 mol % of Y₂O₃, 0-20 mol % of ZrO₂, and 30-60 mol % of Al₂O₃;
20-40 mol % of Y₂O₃, 20-80 mol % of ZrO₂, and 0-60 mol % of Al₂O₃; or
1-99 mol % Y₂O₃ and 1-99 mol % YF₃.

14. The method of claim 12, wherein at least one of the first or second ceramic coatings comprises 30-60 mol % of Y₂O₃, 0-20 mol % of ZrO₂, and 20-50 mol % of Er₂O₃, 0-10 mol % of Gd₂O₃, and 0-30 mol % of SiO₂.

15. The method of claim 12, wherein at least one of the first or second ceramic coatings comprises 30-45 mol % of Y₂O₃, 5-15% mol % of ZrO₂, 25-60 mol % of Er₂O₃, and 0-25 mol % of Gd₂O₃.

16. The method of claim 12, wherein the wherein the metal precursor comprises one or more of metal nitrate, metal sulfate, metal chloride, metal alkoxide, CaF₂, MgF₂, SrF₂, AlF₃, ErF₃, LaF₃, NdF₃, ScF₃, CeF₄, TiF₃, HfF₄, or ZrF₄.

17. The method of claim 12, wherein a first porosity of the first ceramic coating is greater than 1.5%, and a second porosity of the second ceramic coating is less than or equal to 5%.

18. The method of claim 12, wherein a first surface roughness of the first ceramic coating is greater than 150 μin, and a second surface roughness of the second ceramic coating is less than or equal to 300 μin.

19. The method of claim 12, wherein the article is a chamber component selected from a group comprising a lid, a nozzle, an electrostatic chuck, a showerhead, a liner kit, or a ring.

20. (canceled)
